(19) United States
(12) Patent Application Publication
(10) Pub. No.: US 2002/0075895 A1
(43) Pub. Date: Jun. 20, 2002

(54) Transmission rate controller and transmission rate control method

(76) Inventors: Takao Yamaguchi, Kyoto (JP); Tomoaki Itoh, Osaka (JP); Junichi Sato, Nara (JP); Hiroshi Arakawa, Kyoto (JP)

Correspondence Address: HARNESS, DICKEY & PIERCE, P.L.C., P.O. BOX 828, BLOOMFIELD HILLS, MI, 48303, US

(21) Appl. No.: 10/056,963

(22) Filed: Oct. 25, 2001

(30) Foreign Application Priority Data
Oct. 27, 2000 (JP) 2000-328562

(51) Int. Cl. H04J 3/16; H04J 3/22

(52) U.S. Cl. 370/465

(57) ABSTRACT

In order to implement failure-proof media transmission with TCP (Transmission Control Protocol), the following elements are added to a TCP control section, that is, a known transmission processing system: a band estimation section for estimating an available transmission band in a communication path between a transmitting terminal and a receiving terminal, a band management section for setting an upper limit of a band to be used by each TCP session by allocating the available transmission band to each of TCP sessions between the transmitting terminal and the receiving terminal, and a transmission rate management section for limiting a data transmission rate associated with each TCP session according to the preset upper limit of the band to be used.

### BACKGROUND OF THE INVENTION

The present invention relates to a transmission rate controller and a transmission rate control method for controlling a data transmission rate between a transmitting terminal and a receiving terminal according to a congestion state of a transmission path.

On an IP (Internet Protocol) network such as intranet and Internet, an available transmission band varies with time. In order to provide stable transmission quality using such a network, it is necessary to estimate the maximum value of the transmission band that can be assured in a communication path (which is referred to as band estimation), and to change the data transmission rate from a transmitting terminal according to variation in transmission band with time (which is referred to as transmission rate control). In particular, unlike TCP (Transmission Control Protocol), data transmission using UDP (User Datagram Protocol) packets does not conduct flow control in a transport layer. Therefore, the data transmission rate must be controlled in an application layer. Note that RTP (Real Time Transport Protocol)/RTCP (RTP Control Protocol) is known as a protocol for conducting time management on an application-by-application basis.

Hereinafter, related art will be described regarding (1) band estimation and (2) transmission rate control.

(1) Related Art of Band Estimation:

In general, there exist pathchar scheme and Pair Packet scheme as related art of band estimation. Hereinafter, the pathchar scheme and the Pair Packet scheme will be described.

(i) Pathchar scheme: Pathchar by V. Jacobson is well known as one of the band estimation methods in a communication path (ftp://ftp.ee.lbl.gov/pathchar/msri-talk.pdf). Like traceroute, the pathchar is a scheme in which a packet having a TTL (Time To Live) field being set to n is sent so as to cause the nth router on the path to transmit a TTL Expired message of an ICMP (Internet Control Message Protocol) packet, whereby RTT (Round Trip Time) to each router is measured (see A. B. Downey et al., “Using pathchar to estimate Internet link characteristics”, ACM SIGCOMM '99).

In band estimation by the pathchar, the band is estimated from a large amount of RTT data by using statistical processing. Pchar by B. A. Mar is capable of improving the accuracy as well as calculating reliability of the estimated band by conducting this statistical processing method in an ingenious manner (http://www.ca.sandia.gov/-bmah/Software/pchar).

(ii) Pair Packet scheme: band estimation by the Pair Packet scheme is conducted in the following manner: a transmitting terminal continuously sends band estimation packets (examination packets) to a receiving terminal. Due to the difference in packet processing speed between the links, an interval is generated between the band estimation packets after they pass through a bottleneck link. This interval is measured, and the band of the bottleneck link is calculated using the size of the band estimation packets (see R. L. Carter et al., “Measuring Bottleneck Link Speed in Packet-Switched Networks”, Technical Report BU-CS-96-006, Computer Science Department, Boston University, March 1996).

(2) Related Art of Transmission Rate Control

An example of the conventional transmission rate control is a DAA (Direct Adjustment Algorithm) scheme (D. Sisalem et al., “The Direct Adjustment Algorithm: A TCP-Friendly Adaptation Scheme”, Technical Report GMD-FOKUS, August 1997. Available from http://www.fokus.gmd.dc/usr/sisalem). In the DAA scheme, a receiving terminal feeds back information such as RTT of the data and a loss ratio of the data to a transmitting terminal by using RTCP, so that the data transmission rate is changed based on the information.

There is also a scheme in which a single virtual buffer is regarded as being present on a communication path from a transmitting terminal to a receiving terminal, and the transmission rate is controlled so as to make a residual data amount in the virtual buffer closer to the target buffer amount (Japanese Laid-Open Publication No. 11-308271).

The RTP/RTCP is a protocol suitable for transmission of media data requiring a real-time property such as video and audio data. In the RTP/RTCP, however, transmission rate control has been left to application designers. In contrast, in the TCP, transmission rate control is automatically conducted by the system, and therefore the TCP is an attractive protocol to the application designers. Accordingly, it is desired to implement media transmission with the TCP by assuring the conventional connectability with the TCP without significant change in the current TCP framework.

In the conventional transmission rate control of the TCP, however, the transmission rate is sometimes increased beyond a physically available transmission band. This causes packet loss due to congestion, resulting in failure of the data transmission and thus degradation in transmission quality.

### SUMMARY OF THE INVENTION

It is an object of the present invention to implement failure-proof media transmission with TCP.

In order to achieve this object, according to the present invention, a transmission rate controller for controlling a data transmission rate between a transmitting terminal and a receiving terminal includes: a band estimation section for estimating an available transmission band in a communication path between the transmitting terminal and the receiving terminal; a band management section for setting an upper limit of a band to be used by each TCP session by allocating the available transmission band to each of TCP sessions between the transmitting terminal and the receiving terminal; and a transmission rate management section for limiting a data transmission rate associated with each TCP session according to the preset upper limit of the band to be used.

According to the present invention, a transmission rate control method for controlling a data transmission rate between a transmitting terminal and a receiving terminal includes the steps of: estimating an available transmission band in a communication path between the transmitting terminal and the receiving terminal; setting an upper limit of a band to be used by each TCP session by allocating the available transmission band to each of TCP sessions between the transmitting terminal and the receiving terminal; and limiting a data transmission rate associated with each TCP session according to the preset upper limit of the band to be used.

### BRIEF DESCRIPTION OF THE DRAWINGS

FIG. 1 is a block diagram showing an example of the structure of a transmission rate controller according to the present invention;

FIG. 2 is a flowchart illustrating operation of the transmission rate controller shown in FIG. 1; and

FIG. 3 illustrates effects of the transmission rate controller shown in FIG. 1.

### DETAILED DESCRIPTION OF THE INVENTION

Hereinafter, embodiments of the present invention will be described in conjunction with the accompanying drawings.

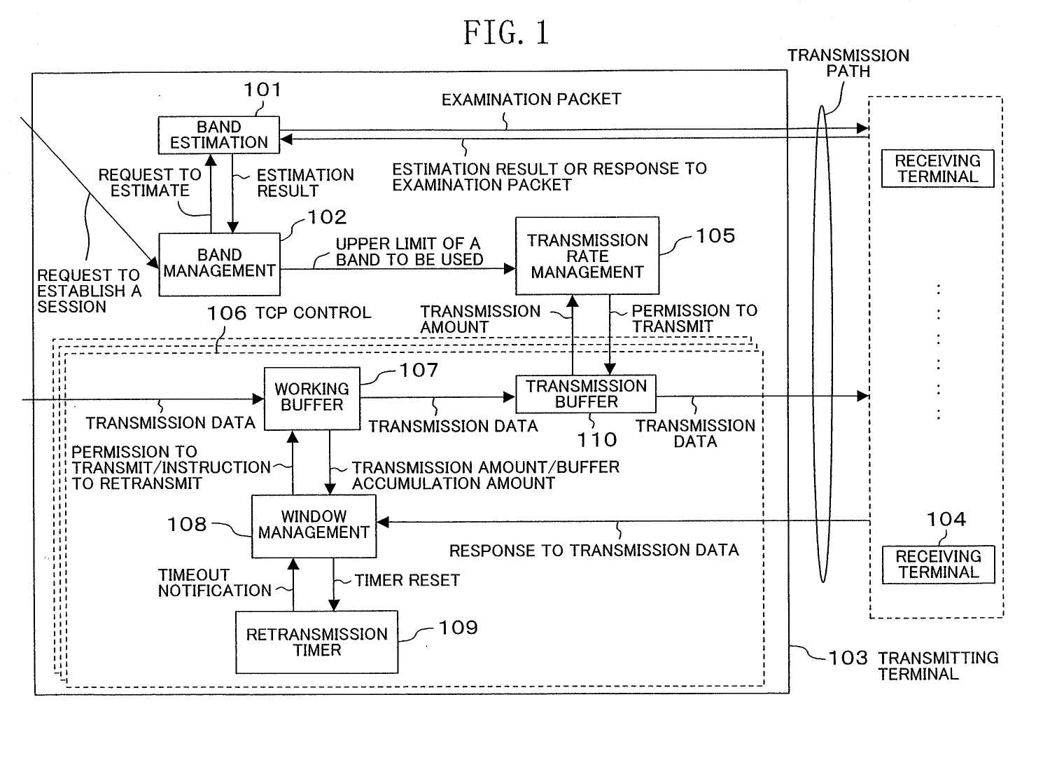

FIG. 1 shows an example of the structure of a transmission rate controller according to the present invention. In a transmitting terminal 103 shown in FIG. 1, a new TCP control section 106 is produced every time a session with a receiving terminal is established, and each TCP control section 106 is eliminated every time processing in a corresponding session is completed. The term “session” as used herein refers to one or more logical transmission paths produced on a physical transmission path between a transmitting terminal and a receiving terminal.

Each of the TCP control sections 106 produced is a known TCP-based transmission processing system, which includes a working buffer 107, a window management section 108, a retransmission timer section 109, and a transmission buffer 110, and can transmit not only accumulated, encoded video/audio data but also real-time encoded video/audio data. More specifically, like a normal TCP, the TCP control section 106 controls the transmission amount (window size) according to acknowledgement of the transmitted data. The window management section 108 increases the window size if acknowledgement is correctly returned from the receiving end. If acknowledgement is not correctly returned, however, the window management section 108 retransmits the data and reduces the window size. Whether acknowledgement is correctly returned or not is determined as follows: the retransmission timer section 109 sets the timer simultaneously with data transmission, and if acknowledgement is returned within the preset timer value, it is determined that the data has been transmitted successfully. It should be noted that the transmission amount control using a window does not necessarily be employed. Instead of the window management section 108, the transmission amount may be controlled based on RTT between the transmitting terminal 103 and a receiving end, as in the case of the conventional DAA scheme. A transmission format and a retransmission method may be the same as those of the normal TCP.

The transmitting terminal 103 in FIG. 1 further includes a band estimation section 101, in response to a request to establish a TCP session between a receiving terminal 104 and the transmitting terminal 103, for estimating an available transmission band in a communication path between the transmitting terminal 103 and the receiving terminal 104, a band management section 102 for setting the upper limit of a band to be used by each TCP session by allocating the available transmission band to each of the TCP sessions between the transmitting terminal 103 and the receiving terminal 104, and a transmission rate management section 105 for limiting the data transmission rate associated with each TCP session according to the preset upper limit of the band to be used. These sections form a transmission rate controller for the TCP control section 106. Conventional band estimation technology need only be used in the band estimation section 101. For example, the conventional band estimation technology includes the aforementioned pathchar scheme and Pair Packet scheme.

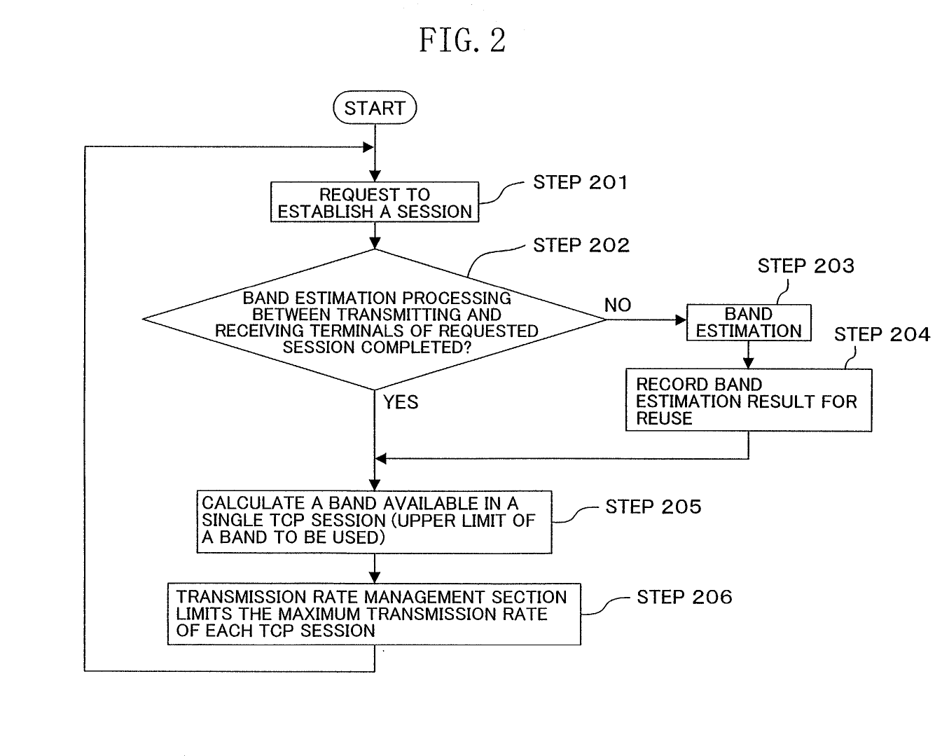

FIG. 2 illustrates operation of the transmission rate controller shown in FIG. 1. The transmitting terminal 103 accepts a request to establish a TCP session at the band management section 102 (step 201). The request to establish a session is made based on an IP address and a port number of the other party. The band management section 102 manages the IP address and the port number of every receiving terminal logically connected to the transmitting terminal 103. The band management section 102 produces a new TCP control section 106 every time a request to establish a session is accepted, and eliminates each TCP control section 106 every time processing for a corresponding session is completed. Thereafter, whether band estimation between the transmitting terminal 103 and the receiving terminal 104 associated with the requested session has already been conducted or not is examined (step 202). If band estimation has not been conducted, the band estimation section 101 estimates a physically available transmission band of a communication path between the transmitting terminal 103 and the receiving terminal 104 (step 203). The band management section 102 receives the estimation result from the band estimation section 101, and records the received estimation result for reuse (step 204). For example, the result that 10 Mbps is available between the transmitting terminal 103 and the receiving terminal 104 is recorded as the estimation result. Moreover, the band management section 102 calculates the upper limit of the transmission band available in a single TCP session, based on the estimation result and the current number of TCP sessions present between the transmitting terminal 103 and the receiving terminal 104, and notifies the transmission rate management section 105 of the calculation result (step 205). For example, provided that there are two sessions between the transmitting terminal 103 and the receiving terminal 104, the upper limit of the band to be used per session is calculated as 5 Mbps. The transmission rate management section 105 limits the maximum transmission rate of each TCP session according to the upper limit of the band to be used (step 206). In other words, the transmission rate management section 105 grants permission to transmit to the transmission buffer 110, and then receives feedback of the transmission amount from the transmission buffer 110, whereby the transmission amount from the transmission buffer 110 to the transmission path can be suppressed.

As has been described above, managing a plurality of TCP sessions with a single band management section 102 enables degradation in transmission quality resulting from competition for a band by a plurality of TCP sessions to be suppressed, and also enables an available band to be used evenly by the plurality of TCP sessions. It should be noted that, if a plurality of TCP sessions are established for the same receiving terminal 104, the band management section 102 may weight allocation of the transmission band between the TCP sessions according to the data type to be transmitted, protocol type, port number, user request and the like. As described in connection with FIG. 2, band estimation is not necessarily conduced twice or more for the same receiving terminal 104. This is because the result of the first estimation need only be used. This enables reduction in overhead of the processing of band estimation that is generated on a session-by-session basis, and suppression in increase in loads of the network.

Note that no matter how the TCP control section 106 is structured, it is desirable that the slow start of the TCP (which refers to setting the transmission rate at the start of transmission to a low value) is not used. This is because, in general, the slow start is not suitable for media transmission. It is also possible to enable the application users to designate the time out interval of the retransmission timer section 109 and the number of times the data can be retransmitted. Alternatively, it is possible to set a retransmission timer value based on the RTT value between the transmitting terminal 103 and the receiving terminal 104.

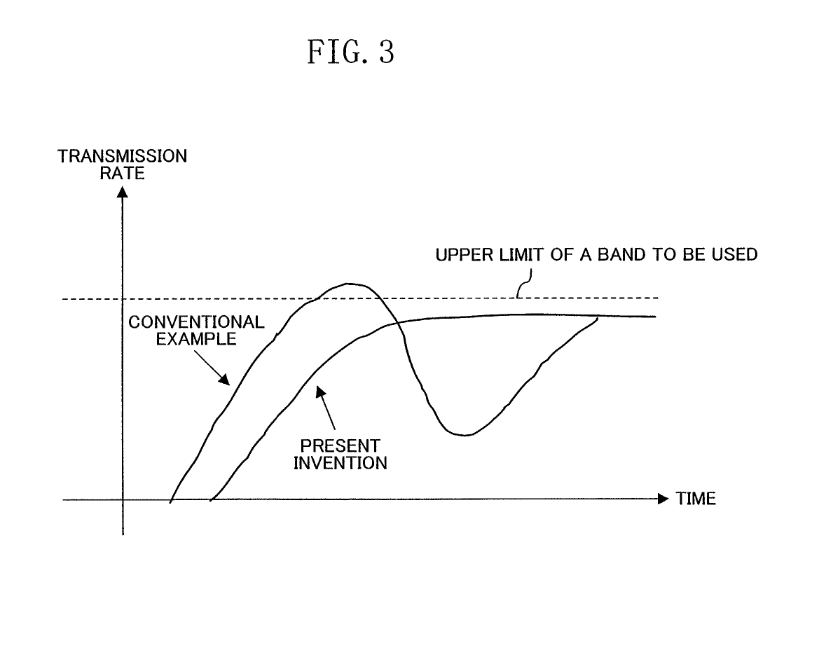

FIG. 3 illustrates effects of the transmission rate controller shown in FIG. 1. The conventional example tends to increase the transmission rate beyond the upper limit of the transmission band available in the TCP session. Transmitting the data at a transmission rate beyond the upper limit results in congestion, causing packet loss (the transmission fails). Accordingly, the transmission rate decreases abruptly, significantly degrading the transmission quality. On the other hand, according to the present invention, the data will not be sent beyond the upper limit of the band to be used in each TCP session, and therefore transmission will not fail. In other words, according to the structure of FIG. 1, the band estimation section 101, the band management section 102 and the transmission rate management section 105 are added to the known TCP control section 106, enabling failure-proof, stable media transmission to be implemented with the TCP.

Note that, although a transmission band available in each TCP session is managed in the above example, it is also possible for the band management section 102 to manage an overall transmission band at the transmitting terminal 103 including UDP sessions.

It should be understood that the present invention is applicable not only to a videophone, video-on-demand, music distribution and the like, but also to a broadcast system.

What is claimed is:

1. A transmission rate controller for controlling a data transmission rate between a transmitting terminal and a receiving terminal, comprising:
a band estimation section for estimating an available transmission band in a communication path between the transmitting terminal and the receiving terminal;
a band management section for setting an upper limit of a band to be used by each TCP session by allocating the available transmission band to each of TCP sessions between the transmitting terminal and the receiving terminal; and
a transmission rate management section for limiting a data transmission rate associated with each TCP session according to the preset upper limit of the band to be used.

2. A transmission rate control method for controlling a data transmission rate between a transmitting terminal and a receiving terminal, comprising the steps of:
estimating an available transmission band in a communication path between the transmitting terminal and the receiving terminal;
setting an upper limit of a band to be used by each TCP session by allocating the available transmission band to each of TCP sessions between the transmitting terminal and the receiving terminal; and
limiting a data transmission rate associated with each TCP session according to the preset upper limit of the band to be used.
